(19) United States
(12) Patent Application Publication
(10) Pub. No.: US 2015/0094200 A1
(43) Pub. Date: Apr. 2, 2015

(54) METHOD OF MAKING FUEL CELL CATALYST

(71) Applicant: Ford Global Technologies, LLC, Dearborn, MI (US)

(72) Inventors: Chi Paik, Brownstown Twsp., MI (US); Lifeng Xu, Northville, MI (US); Hungwen Jen, Troy, MI (US); Karen Marie Adams, Ann Arbor, MI (US); Mark S. Sulek, Sterling Heights, MI (US); Sherry A. Mueller, Plymouth, MI (US)

(21) Appl. No.: 14/537,135

(22) Filed: Nov. 10, 2014

Related U.S. Application Data
(63) Continuation of application No. 12/507,922, filed on Jul. 23, 2009.

(51) Int. Cl. H01M 4/88; H01M 4/90

(52) U.S. Cl. CPC H01M 4/8878; H01M 4/9083
USPC 502/5; 502/301

(57) ABSTRACT

A method including the steps of combining a catalyst metal and a leachable metal to obtain a metallic alloy; and electrochemically removing at least a portion of the leachable metal from the metallic alloy to form a catalyst structure having nanometric pores.

### CROSS-REFERENCE TO RELATED APPLICATIONS

This application is a continuation of U.S. application Ser. No. 12/507,922 filed Jul. 23, 2009, the disclosure of which is hereby incorporated in its entirety by reference herein.

### TECHNICAL FIELD

The present invention relates to a method of making a fuel cell catalyst.

### BACKGROUND

Effective and environmentally clean power generation has become a world-wide concern. Proton exchange fuel cells (PEMFCs), which electrochemically convert chemical energy of a fuel directly into electrical energy, has gained attention as a promising power source for electrically powered vehicles, for small-scale stationary power generation and for portable electronics devices.

A fuel cell consists of two electrodes, an anode and a cathode, separated by an electrolyte. The electrodes are electrically connected through an external circuit, with a resistance load lying in between them. Solid polymer electrochemical fuel cells generally employ a membrane electrode assembly (MEA) containing a solid polymer electrolyte membrane (PEM), also known as a proton exchange membrane, in contact with the two electrodes.

Current fuel cell technologies use noble metals, including platinum, in the anode and/or the cathode electrode(s) as reaction catalysts.

### SUMMARY

According to one embodiment, a method is disclosed including the steps of combining a catalyst metal and a leachable metal to obtain a metallic alloy; and removing at least a portion of the leachable metal from the metallic alloy by potential cycling to form a catalyst structure having nanometric pores. The method may further include monitoring the loss of catalyst metal from the metallic alloy to the catalyst structure during the removing step. The removing step may be discontinued based on the monitored level of catalyst metal loss. The catalyst metal loss may be less than 20 ppm or 10 weight percent. The method may further include depositing the metallic alloy on a substrate prior to the removing step. The removing step may be carried out while the metallic alloy is deposited on the substrate.

According to another embodiment, a disclosed method includes combining a catalyst metal and a leachable metal to obtain a metallic alloy; and removing at least a portion of the leachable metal from the metallic alloy by inductive coupled plasma spectroscopy (ICP) to form a catalyst structure having nanometric pores. The method may further include monitoring the loss of catalyst metal from the metallic alloy to the catalyst structure during the removing step. The removing step may be discontinued based on the monitored level of catalyst metal loss. The catalyst metal loss may be less than 20 ppm or 10 weight percent. The method may further include depositing the metallic alloy on a substrate prior to the removing step. The removing step may be carried out while the metallic alloy is deposited on the substrate.

In yet another embodiment, a disclosed method includes combining a catalyst metal and a leachable metal to obtain a metallic alloy; and electrochemically removing at least a portion of the leachable metal from the metallic alloy to form a catalyst structure having nanometric pores. The electrochemically removing step may be carried out using potential cycling. The potential cycling may be carried out with a shaped wave with a scan rate of 25 to 75 millivolts per second (mv/s). The electrochemically removing step may be carried out using inductive coupled plasma spectroscopy (ICP). The ICP may be carried out using an induction coil to produce a magnetic field within the metallic alloy. The ICP may be operated at 0.5 to 10 kilowatts (kWs).

### BRIEF DESCRIPTION OF THE DRAWINGS

FIG. 1 shows improvement of PEM fuel cell performance after leaching of a PtRhCo catalyst;

FIG. 2A shows comparative test results of platinum loss between the following three catalysts: PtCo/C, PtRhCo/C, and PtFe/C;

FIG. 2B shows comparative results of the extent of cation leaching among the catalysts identified in connection with FIG. 2A;

FIG. 3 shows controlled potential cycling of PtRhCo/C configured as a cathode showing increased electrochemical area in the initial 100 minutes; and

FIG. 4 illustrates various components of an exemplary fuel cell.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention. Practice within the numerical limits stated is generally preferred.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

As a component of a fuel cell adapted for use in a mobile vehicle, electrodes for the anode and the cathode have been increasingly investigated in automobile research and development for improved cell power generation.

Platinum is a well-known catalyst metal used in electrochemical cells. Electrode performance in a fuel cell is directly related to the amount of surface area of platinum which can be reached by the various reacting species within the cell.

Catalysts employing noble metals generally have greater catalytic activity and specificity than the base metal catalysts, however, these noble metals are much less plentiful and much more costly than the base metals. The high cost coupled with the limited availability of the noble metals have impacted some large scale applications such as fuel cell vehicle productions. The current state of the art typically requires about one-third to one-half ounce of platinum for a fuel cell vehicle. Reducing the use of noble metals such as platinum in the fuel cell vehicle production has been a long felt but unmet need.

It has been found, and as demonstrated in various embodiments of the present invention, that the consumption of noble metals as electrochemical catalyst for use in a fuel cell application may be substantially reduced by the employment of a catalyst with surface area enhanced through leaching by potential cycling. When presented in a leached-out configuration as described herein, the catalyst exhibits a relatively higher voltage output, and consequently a lower consumption of the noble metals such as platinum is realized.

For the purpose of illustration, an exemplary fuel cell 420 is schematically depicted in FIG. 4. The fuel cell 420 includes a pair of bi-polar plates 422 and 424 having grooves 426 and 428 formed at a predetermined interval on both sides of each of the bi-polar plates 422 and 424. The fuel cell 420 also includes an ionic exchange membrane 434 disposed midway between the bi-polar plates 422 and 424, a first electrode such as an air electrode 432 disposed between the ionic exchange membrane 434 and the bi-polar plate 424, and a second electrode such as a fuel electrode 430 disposed between the ionic exchange membrane 434 and the bi-polar plate 422.

The bi-polar plates 422 and 424 are for electrically connecting the air electrode 432 and the fuel electrode 430, and preventing fuel and air (an oxidizer) from being mixed. The grooves 426 and 428 are used as fuel and air passages in the cells connected end to end.

In the above described solid polymer type fuel cell, such an expensive catalyst as platinum or a platinum-based alloy catalyst is used in a relatively large amount. For instance, about 1 mg/cm² per cell and, therefore, the electrode catalyst cost forms a substantial proportion of the cell model cost. Therefore, to reduce the usage of the noble metal catalyst is one task in putting fuel cells to practical use.

One or more embodiments of the present invention relate to catalysts with improved hydrogen power generation in a fuel cell compartment resulting from comparably reduced consumption of noble metals, such as platinum. Reducing the consumption of costly noble metals while maintaining an industrially acceptable cell voltage generation enables a much improved energy per dollar value adapted for mass production of the fuel cell vehicles.

According to at least one aspect of the present invention, a fuel cell catalyst formed from a metallic alloy of one or more catalyst metals and one or more leachable metals through potential cycling to remove at least a portion of the leachable metals is disclosed. An effective catalytic surface area of the fuel cell catalyst per a given amount of the catalyst metals is enhanced accordingly.

In at least one embodiment, the fuel cell catalyst is provided with an effective catalytic surface area of no less than 65 square meter per gram of the total weight of the catalyst metals prior to the potential cycling. In certain particular instances, the effective catalytic surface area of the fuel cell catalyst is no less than 70, 90, 110, or 130 to no greater than 200, 180, 160, or 140 square meter per gram. The catalytic surface can be determined by any suitable method and in particular can be determined by carbon monoxide (CO) or hydrogen adsorption/desorption measurements. Therefore, the instant catalyst according to one or more embodiments of the present invention is defined over conventional catalysts and particularly those platinum based catalysts at least in that the instant catalyst offers a relatively higher catalytic surface area, for instance, equal or greater than 65 square meter per gram as opposed to corresponding values in the art of no greater than 60 square meter per gram.

It has also been found the fuel cell catalyst according to one or more embodiments of the present invention is able to deliver a voltage-current performance of the fuel cell of no less than 0.55 volts, or in certain particular embodiments of between 0.55 to 0.7 volts at a current density of 1 ampere per square centimeter. Therefore, the instant catalyst according to one or more embodiments of the present invention is further defined over conventional catalysts and particularly those platinum based catalysts in that the instant catalyst, when used in a fuel cell, enables a relatively higher fuel cell performance, for instance, equal or greater than 0.55 volts at 1 ampere per square centimeter versus the conventional of no greater than 0.5 volts at 1 ampere per square centimeter.

As used herein and unless otherwise noted, the term “current density” refers to an amount of electric current in unit of ampere(s) per square centimeter of a planar surface of the fuel cell in which the catalyst is adapted to be used. An example of the planar surface includes the air electrode 432 and the fuel electrode 430 as depicted in FIG. 4.

In at least yet another embodiment, the fuel cell catalyst is configured as a micro-porous shell having an average pore diameter of no greater than 2 nanometers, as a meso-porous shell having an average pore diameter of between 2 and 50 nanometers, as a macro-porous shell having an average pore diameter of no less than 50 nanometers, as checkered multi-phase layers, or any combinations thereof.

In at least another embodiment, the catalyst metals are selected from the group consisting of ruthenium (Ru), rhodium (Rh), palladium (Pd), rhenium (Re), osmium (Os), iridium (Ir), platinum (Pt), gold (Au), and combinations thereof.

In at least yet another embodiment, the leachable metals are selected from the group consisting of nickel (Ni), cobalt (Co), molybdenum (Mo), manganese (Mn), chromium (Cr), tungsten (W), thorium (Th), zinc (Zn), copper (Cu), lead (Pb), and combinations thereof.

In at least one particular embodiment, the metallic alloy is formed of platinum as the catalyst metal and nickel as the leachable metal. As such, the metallic alloy may be represented by the formula of (Pt)ₐ(Ni)ₘ, wherein the ratio of a/m is between 1:10 to 10:1.

In at least another particular embodiment, the metallic alloy is formed of platinum as the catalyst metal and cobalt as the leachable metal. As such the metallic alloy may be represented by the formula of (Pt)ₐ(Co)ₙ, wherein the ratio of a/n is between 1:10 to 10:1.

In at least yet another particular embodiment, the metallic alloy is formed of platinum as the catalyst metal and nickel and cobalt as the leachable metals. As such, the metallic alloy may be represented by the formula of (Pt)ₐ(Ni)ₘ(Co)ₙ, wherein the ratio of a/m and the ratio of a/n is each independently a value between 1:10 to 10:1.

An alloy or a metallic alloy as used herein and unless otherwise indicated, refers to a mixture of metals wherein at least one component metal presents crystal structure that differs from respective original structure of the metal in its pure metal form.

Alloying the catalyst metals with the leachable metals advantageously reduces crystal agglomeration among the catalyst metal particles. By separating the crystal particles of the catalyst metal particles through the introduction of the leachable metals via the process of alloying, an initial enhancement on the effective surface area of the catalyst metal is realized.

The metallic alloy according to one or more embodiments of the present invention can be formed by any suitable method. One such method may be mechanical grinding. For instance, the catalyst metal and the leachable metal are combined in a crucible containing a number of grinding balls and ground under an argon atmosphere. The number of grinding balls is adjusted to amount to a total weight based on the amount of the catalyst metal and the leachable metal used. A weight ratio between the total weight of the grinding balls and the total weight of the metals is adjusted according to the composition of the metals involved. In certain particular instances, a weight ratio of 3 to 6 so defined may be used. The grinding may be carried out for a period of time, and typically 35 to 45 hours, until no change is observed in the crystalline structure of the combined metals.

In at least another embodiment, at least a portion of the leachable metals are leached out of the metallic alloy by potential cycling. As such, the removing step does not require the removal of all the leachable metals, but only at least a portion of the plurality of the leachable metals.

In at least yet another embodiment, the leachable metals are substantially removed from the metallic alloy to enhance the catalytic surface area of the at least one catalyst metal.

The term “substantial” or “substantially” as described herein means that a residual amount of the leachable metals present in the fuel cell catalyst after the potential cycling is no greater than 5 weight percent of the total weight of the metallic alloy prior to potential cycling. In the event that less than 100 percent by weight of the all the leachable metals are removed, the unremoved leachable metals are not detrimental to other components of a fuel cell since the leachable metals are chosen to be Fenton poor agents as described herein.

It has been found, according to one or more embodiments of the present invention, that alloying noble metals such as platinum with certain less expensive metallic elements such as iron is preferably not employed. Fenton rich metallic elements such as iron are less stable than platinum and tend to permeate through the fuel cell electrolyte membrane and hence cause membrane toxication. The leachable metals according to one or more embodiments of the present invention are Fenton poor agents such that any accidental leakage of the leachable elements from an alloy composition does not electrochemically attack the ionic exchange membrane. Since iron is categorized as a Fenton rich agent and therefore is largely not preferred in practicing the present invention.

As used herein and unless otherwise indicated, the term “Fenton value” or “Fenton testing value” refers to the ability of an ion to decompose the peroxide to radicals which may be harmful to an electrochemical membrane. The Fenton testing value or Fenton value can be measured by the amount of fluoride released from a 30% hydrogen peroxide solution as affected by the ion. As such, a Fenton rich agent is an ion that actively induces the decomposition of the peroxide and the release of fluoride in a fuel cell compartment.

According to one or more embodiments of the present invention, a resultant fuel cell catalyst product after the “controlled leaching” has a morphology that is similar to the one of a sponge that has nanometric pores. In the field of catalytic reactions for a fuel cell, reactant species such as gases or solvated ions that chemically react with each other must stay for a given time on the surface of the catalyst in order to obtain the requested catalytic effect. Therefore, the amount of species that will react as a function of time will be directly related to the effective surface of the catalyst.

Methods according to various embodiments of the present invention strategically aim to reduce the consumption of catalyst metals such as platinum by controllably removing the leachable metals from the previously formed metallic alloy and to create a porous interface between the catalyst metal and the reactants for the fuel cell energy generation.

According to at least one aspect of the present invention, a method is provided for making a fuel cell catalyst with enhanced catalytic surface area with terms as described herein. In at least one embodiment, the method includes providing a metallic alloy of one or more catalyst metals and one or more leachable metals, and removing the at least one leachable metal from the at least one metallic alloy by potential cycling such that an effective catalytic surface area of the fuel cell catalyst is enhanced accordingly.

In at least one particular embodiment, the removing step is carried out through electrochemical leaching such as potential cycling. Potential cycling is often used for cleaning and or activating an electrode surface before an electrochemical application. Potential cycling of a metal electrode to a higher potential region dissolves the metal in certain conditions.

According to one or more embodiments of the present invention, potential cycling may be carried out in any suitable procedure. One exemplary procedure may be carried out as follows. A two-electrode potentiostatic circuit is used. Hydrated pure nitrogen is passed through a working electrode (fuel cell cathode) compartment, whereas hydrated pure hydrogen is passed through a counter electrode (fuel cell anode) compartment. The circuit is maintained at atmospheric pressure and at a temperature of from 60 to 120 degrees Celsius. The potential is cycled by a shaped wave, such as a triangular wave. At a scan rate of from 25 to 75 millivolts per second (mv/s). The anode serves as a reference electrode as well as a counter electrode. The electrochemically active surface area is evaluated from the hydrogen desorption charge of a cyclic voltammogram.

In at least another embodiment, the potential cycling can also be conducted in an acid containing environment. Since the fuel cell may have already been in a very acidic environment during operation, the potential cycling may be conducted on board during fuel cell's normal operation period.

In at least another embodiment, the removing step is carried out, at least concurrently with the electrochemical leaching through potential cycling, through an acid leaching operated under a set of controlling variables. The controlling variables illustratively include leaching temperature, type of the acid, rate of acid addition, and concentration of the acid. In certain particular instances, the acid may be HCl, H₂SO₄, H₃PO₄, or combinations thereof. The concentration of the acid may be of any suitable value. A suitable acid concentration may be in a range of 15% to 75%, 25% to 65%, or 35% to 55%. In certain other particular instances, the acid is added in a paced manner, and particularly via dropwise addition of the acid. A consideration for the paced addition of the acid is not to disturb the at least one catalyst metal while at the same time the at least one leachable metal is leached out. In other words, the amount of the acid added and the speed of acid addition are regulated such that the atomic composition of the final product after leaching is controllably desirable for the particular application at hand. Based on simple and routine experimentation, one is able to optimize a set of leaching variables best suitable for a particular leaching procedure.

Regardless of whether a potential cycling and/or an acid leaching is used for the removing step, the metallic alloy may be directly subjected to the removing step or be first supported on a substrate before being subjected to the removing step. For the latter, the metallic alloy may be further grinded together with the substrate such as carbon black, to further include the substrate in fine particulate form.

The substrate is generally characterized as being electrically conductive and chemically inert. The conductivity of the substrate may vary, and in certain applications is comparable or the same to that of carbon. The substrate is chemically inert such that the substrate may be prevented from being reacting to the hydrogen fuel. Some examples of materials suitable for the substrate include carbon black, metal nitride such as titanium nitride, metal carbide such as tungsten carbide, or combinations thereof.

It has been advantageously found that the leachable metals can be controllably leached out of the metallic alloy according to one or more embodiment of the present invention wherein the incidental platinum loss is substantially kept to a minimum. In certain particular instances, the incidental loss of the catalyst metals such as platinum is less than 20 ppm, 10 ppm, or 5 ppm. As such, contrary to other liquid leaching processes where noble metals are often inevitably lost concurrent to a leaching process, the controlled leaching according to one or more embodiments of the present invention is carried out electrochemically wherein the degree of leaching can be closely monitored and the leaching can be terminated upon a predetermined leached-out amount of noble metal is first detected. One example of the electrochemical controlled leaching process is carried out by inductively coupled plasma spectroscopy (ICP). A desirable degree of leaching is realized when the incidental loss of the catalyst metals is reasonably kept at a minimum while the leachable metals are substantially removed.

ICP typically utilizes a plasma as the atomization and excitation source. A plasma is an electrically neutral, highly ionized gas that consists of ions, electrons, and atoms. The energy that maintains an analytical plasma is derived from an electric or magnetic field and therefore, it does not burn. An exemplary ICP is a radio frequency induced plasma that uses an induction coil to produce a magnetic field. The ICP often operates between 0.5 and 10 kilowatts, and in certain applications, 1 and 5 kilowatts. ICP torch in use has evolved over decades of development. A common ICP torch uses a circular quartz tube having several separate gas inlets and the gas routinely used is argon.

Both argon and nitrogen may be used independently from each other in the application of ICP. Being present in 0.9% of the earth atmosphere, argon is readily available. Nitrogen emits several molecular bands in the ultraviolet and the visible, so overlaps with analytical lines are possible. Despite the limitation, nitrogen has been successfully used as the carrier gas for ICP.

In accordance to one or more embodiments of the present invention, the incidental loss of the catalyst metals should be monitored by methods such as ICP as described herein and be kept at a suitable minimum. The suitable minimum may be a predetermined value dependent on the composition of the metallic alloy used. In general, the incidental loss of the catalyst metals should be no greater than 10, 8, 6, 4, 2, or 0.5 weight percent of the total weight of the catalyst metals present in the metallic alloy prior to the step of leaching such as potential cycling.

The fuel cell catalyst with enhanced catalytic surface area as described herein can be used as an electro catalyst in electric laser or incorporated into the electrodes of electrolyte fuel cells. More particularly, the catalyst can be used in a fuel cell having a solid polymeric electrolyte.

### EXAMPLES

### Example 1

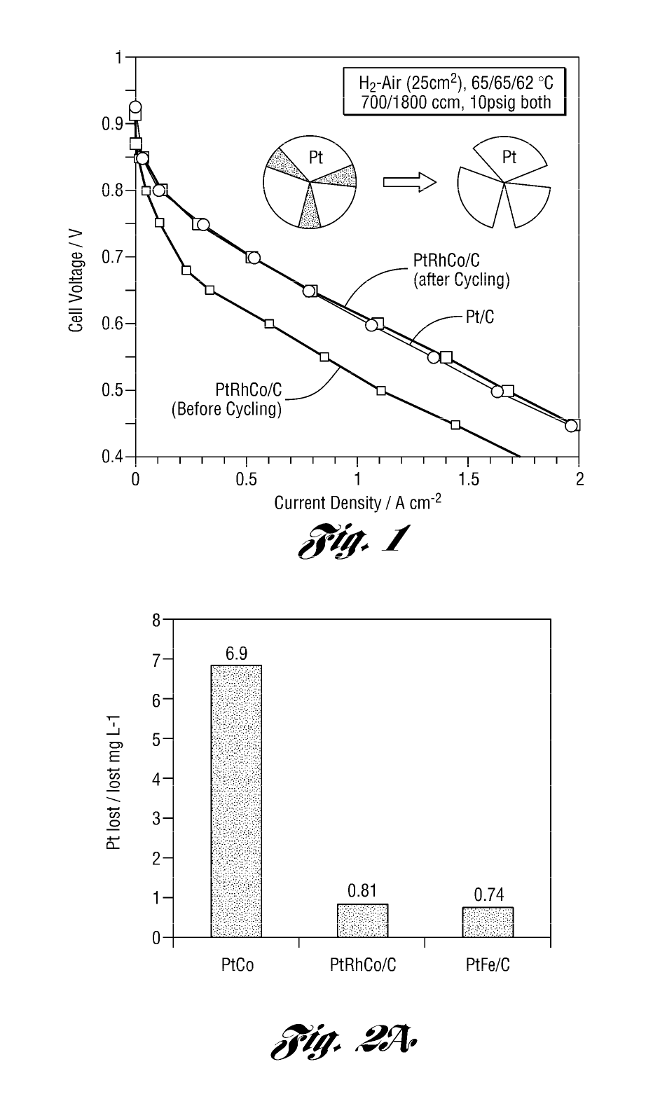

FIG. 1 depicts fuel cell performance presented in cell voltage as a function of current density measured by ICP. The potential cycling is carried under the experimental conditions H₂-Air (25 cm²), 65/65/62 ° C., 70/1800 CCM, 10 psig both. The potential cycling is conducted under fully humidified H₂/N₂ voltage applied externally with a potentiostat.

As depicted in FIG. 1, a baseline composition of pure platinum on carbon black is represented by the line with circles. A catalyst composition having one third of the platinum substituted with base metals is represented by the line with solid squares, wherein the line with smaller solid squares represents the substituted catalyst composition before potential cycling and the line with larger solid squares represents the substituted catalyst composition after potential cycling.

It is demonstrated in FIG. 1 that with metallic alloying coupled with selective leaching thereafter, the catalyst composition with a much reduced amount of platinum consumption still delivers cell voltages substantially comparable to the voltage production provided by the baseline platinum composition.

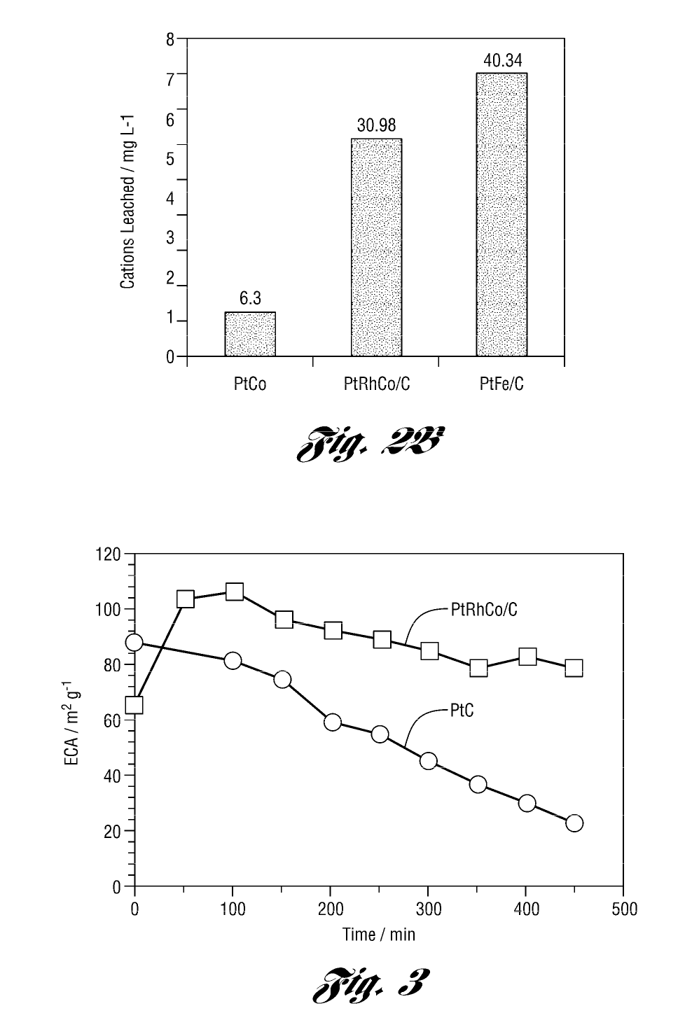

Of the three metallic alloys tested, namely, PtCo/C, PtRhCo/C, and PtFe/C, and as shown in FIGS. 2A and 2B, the metallic alloy of PtFe/C presents the most amount of leaching of the leachable metal Fe and the least amount of platinum loss. In contrast, the metallic alloy of Pt/Co/C presents the least amount of leaching of the leachable metal Co and the significantly highest amount of platinum loss. However, iron (Fe) is not recommended to be used as the leachable metal at least since iron is a Fenton rich agent. In this particular example, the metallic alloy PtRhCo/C seems to be more effective than the other comparable compositions tested in the example while being relatively benign to fuel cell electrodes.

An amount of Pt loss less than approximately 2 ppm allows high stability to the membrane.

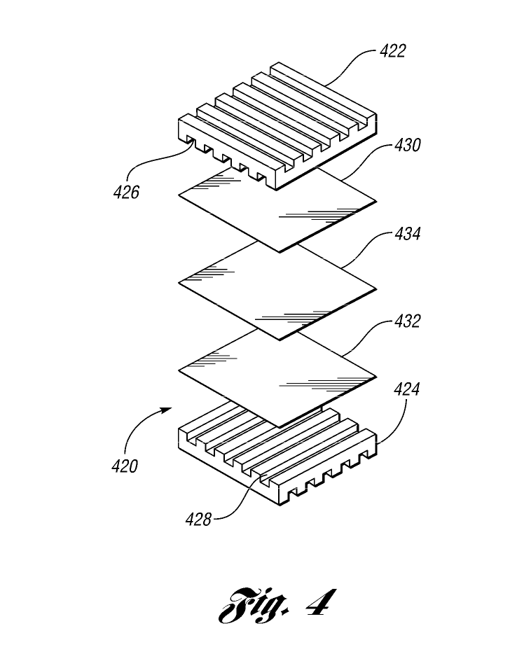

FIG. 3 depicts acid corrosion measurements of the catalyst composition PtRbCo/C in relation to the baseline composition Pt/C as a function of time. The acid corrosion measurements are presented in the electrochemical area “ECA”. As depicted in FIG. 3, the metallic alloy PtRbCo/C after leaching shows higher ECA values in comparison to the baseline composition. ECA is measured electrochemically in humidified H₂/N₂ with a potentiostat. Hydrogen adsorption is measured with time. Hydrogen and CO adsorption/desorption can be sued to measure ECA.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method comprising:
combining a catalyst metal and a leachable metal to obtain a metallic alloy; and
removing at least a portion of the leachable metal from the metallic alloy by potential cycling to form a catalyst structure having nanometric pores.

2. The method of claim 1, further comprising:
monitoring the loss of catalyst metal from the metallic alloy to the catalyst structure during the removing step.

3. The method of claim 2, wherein the removing step is discontinued based on the monitored level of catalyst metal loss reaching a predetermined catalyst metal loss.

4. The method of claim 3, wherein the predetermined catalyst metal loss is less than 20 ppm.

5. The method of claim 3, wherein the predetermined catalyst metal loss is less than 10 weight percent.

6. The method of claim 1, further comprising depositing the metallic alloy on a substrate prior to the removing step.

7. The method of claim 1, wherein the removing step is carried out while the metallic alloy is deposited on the substrate.

8. A method comprising:
combining a catalyst metal and a leachable metal to obtain a metallic alloy; and
removing at least a portion of the leachable metal from the metallic alloy by inductive coupled plasma spectroscopy (ICP) to form a catalyst structure having nanometric pores.

9. The method of claim 8, further comprising:
monitoring the loss of catalyst metal from the metallic alloy to the catalyst structure during the removing step.

10. The method of claim 9, wherein the removing step is discontinued based on the monitored level of catalyst metal loss reaching a predetermined catalyst metal loss.

11. The method of claim 10, wherein the predetermined catalyst metal loss is less than 20 ppm.

12. The method of claim 10, wherein the predetermined catalyst metal loss is less than 10 weight percent.

13. The method of claim 8, further comprising depositing the metallic alloy on a substrate prior to the removing step.

14. The method of claim 13, wherein the removing step is carried out while the metallic alloy is deposited on the substrate.

15. A method comprising:
combining a catalyst metal and a leachable metal to obtain a metallic alloy; and
electrochemically removing at least a portion of the leachable metal from the metallic alloy to form a catalyst structure having nanometric pores.

16. The method of claim 15, wherein the electrochemically removing step is carried out using potential cycling.

17. The method of claim 16, wherein the potential cycling is carried out with a shaped wave with a scan rate of 25 to 75 millivolts per second (mv/s).

18. The method of claim 15, wherein the electrochemically removing step is carried out using inductive coupled plasma spectroscopy (ICP).

19. The method of claim 18, wherein the ICP is carried out using an induction coil to produce a magnetic field within the metallic alloy.

20. The method of claim 15, wherein the ICP is operated at 0.5 to 10 kilowatts (kWs).
